(19) United States
(12) Patent Application Publication
(10) Pub. No.: US 2015/0065182 A1
(43) Pub. Date: Mar. 5, 2015

(54) MOBILE-DEVICE SYSTEMS AND METHODS FOR EMPOWERED LOCAL COMMUNICATION

(71) Applicant: Amby App, LLC, Dallas, TX (US)

(72) Inventor: Thomas Adams, Dallas, TX (US)

(21) Appl. No.: 14/474,269

(22) Filed: Sep. 1, 2014

Related U.S. Application Data
(60) Provisional application No. 61/873,225, filed on Sep. 3, 2013.

(51) Int. Cl. H04W 4/12; H04W 64/00; H04W 4/02

(52) U.S. Cl. CPC H04W 4/12; H04W 4/02; H04W 64/00
USPC 455/466

(57) ABSTRACT

Methods, systems, programs, and devices are presented that enable local communication between client devices, e.g., smart phones, while allowing self-policing of content by the recipients. In one instance, messages created in a certain communication area are transmitted to other users in that geographical area. Users may attenuate a message, which sends a request that a communication zone of that message be decreased. In some instances, users may also request that a message be amplified, which sends a request for the communication zone of that message to be enlarged. Other embodiments and features are presented.

### FIELD

This application is directed, in general, to mobile phones and communication devices, and more specifically, to mobile devices, systems, and methods for local empowered communication.

### BACKGROUND

Today many people throughout the world have smart phones that allow powerful communications and processing to occur in a user's hand. Many mobile applications have been developed for such devices, whether iPhones, Androids, or other devices, and yet many additional needs have yet to be addressed.

### BRIEF DESCRIPTION

Illustrative embodiments of the present disclosures are described in detail below with reference to the attached drawing figures, which are incorporated by reference herein and wherein:

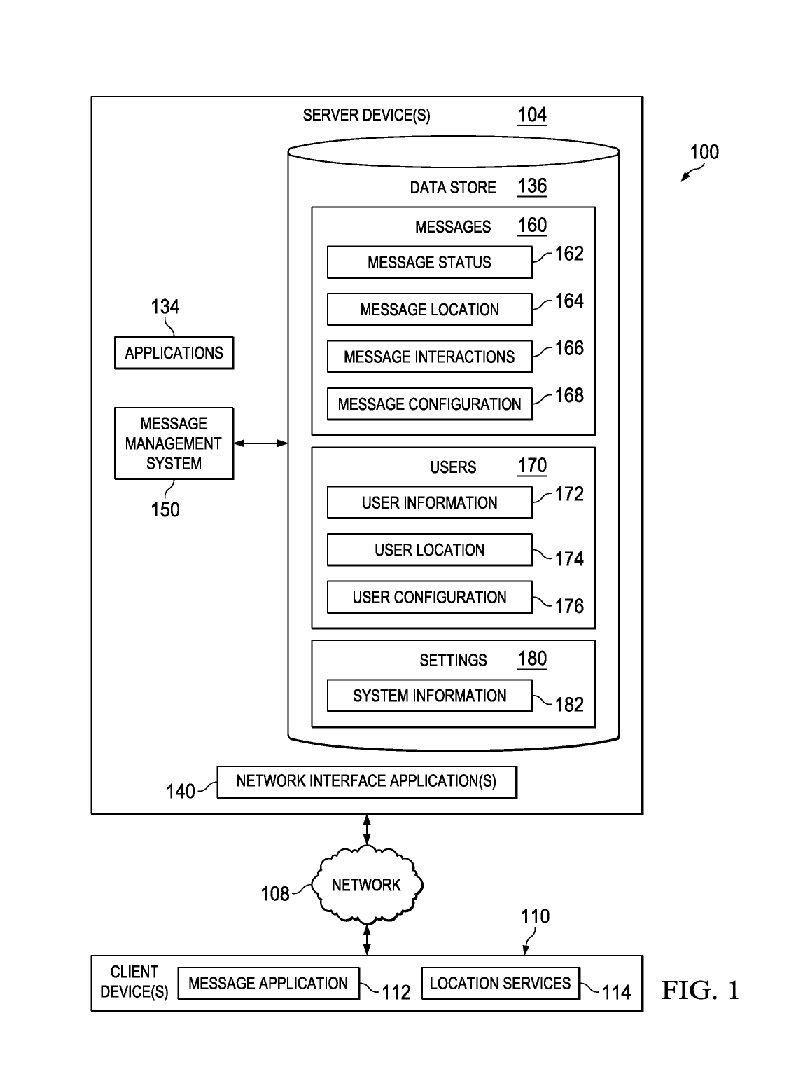

FIG. 1 is a schematic drawing of an illustrative networked environment according to various embodiments of the present disclosure;

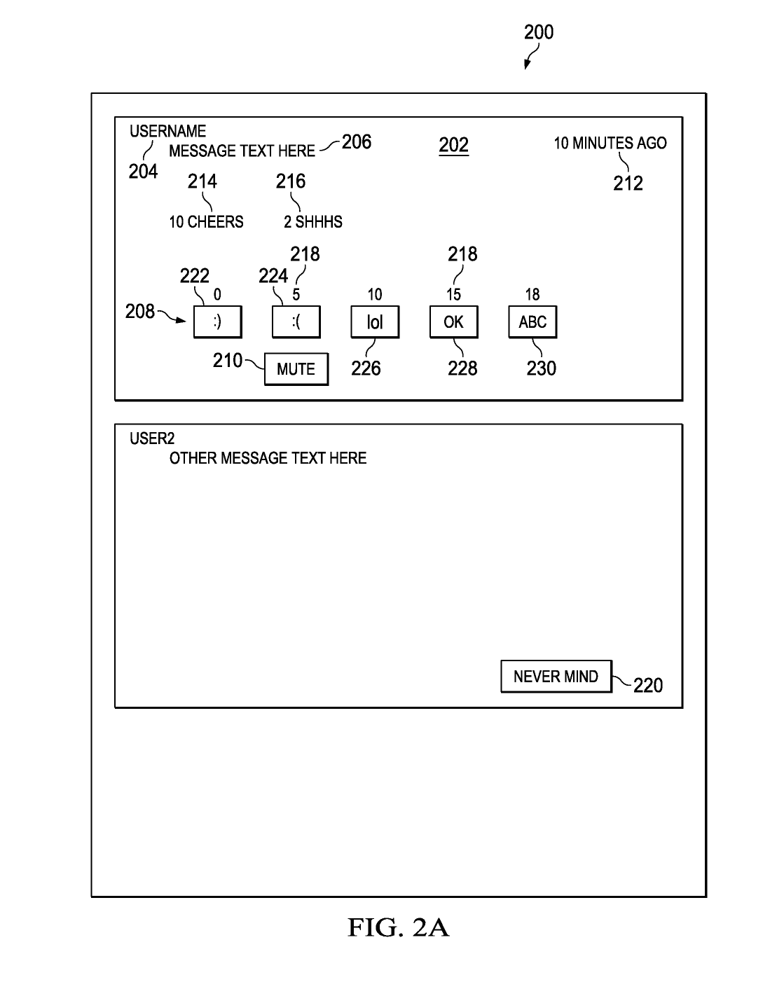

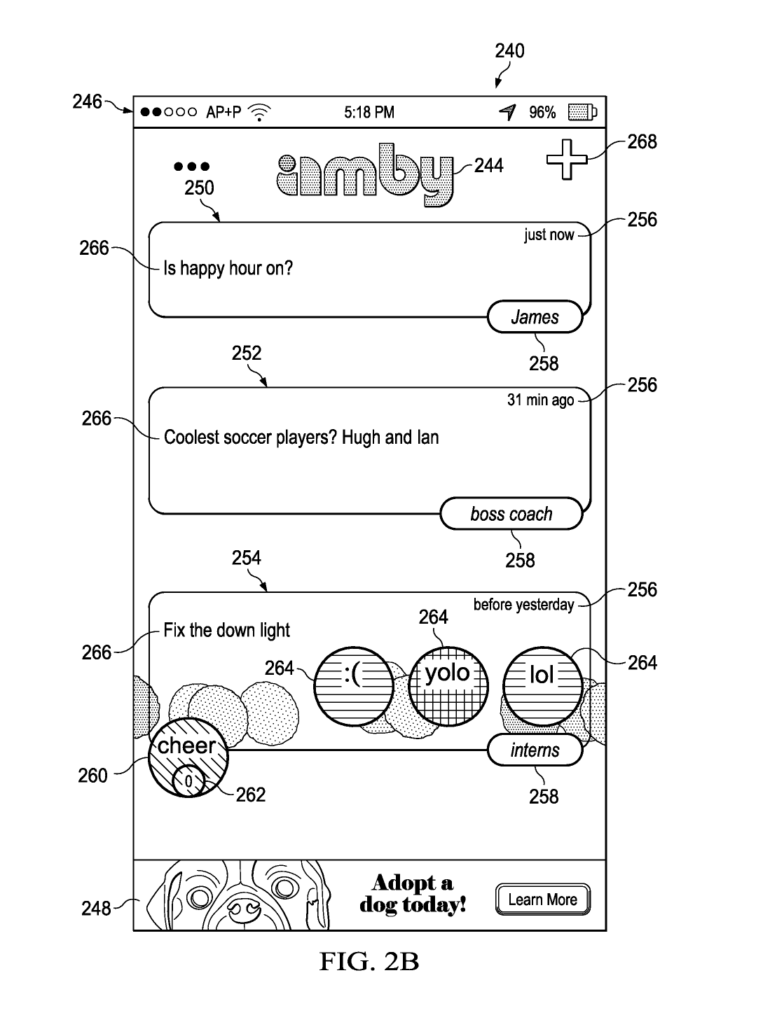

FIGS. 2A and 2B are schematic drawings of illustrative user interfaces for use with an illustrative embodiment of the present disclosure;

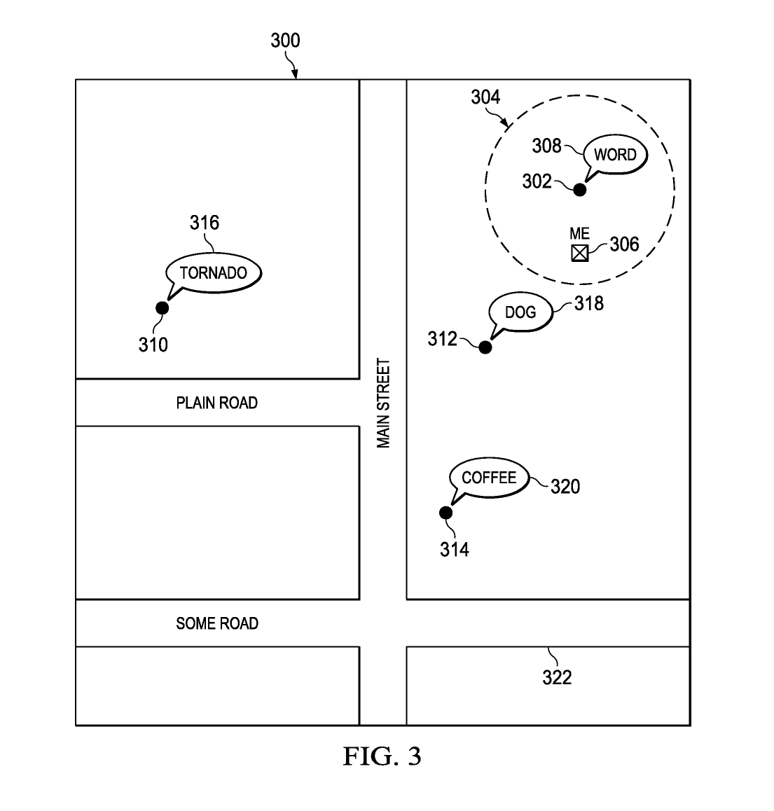

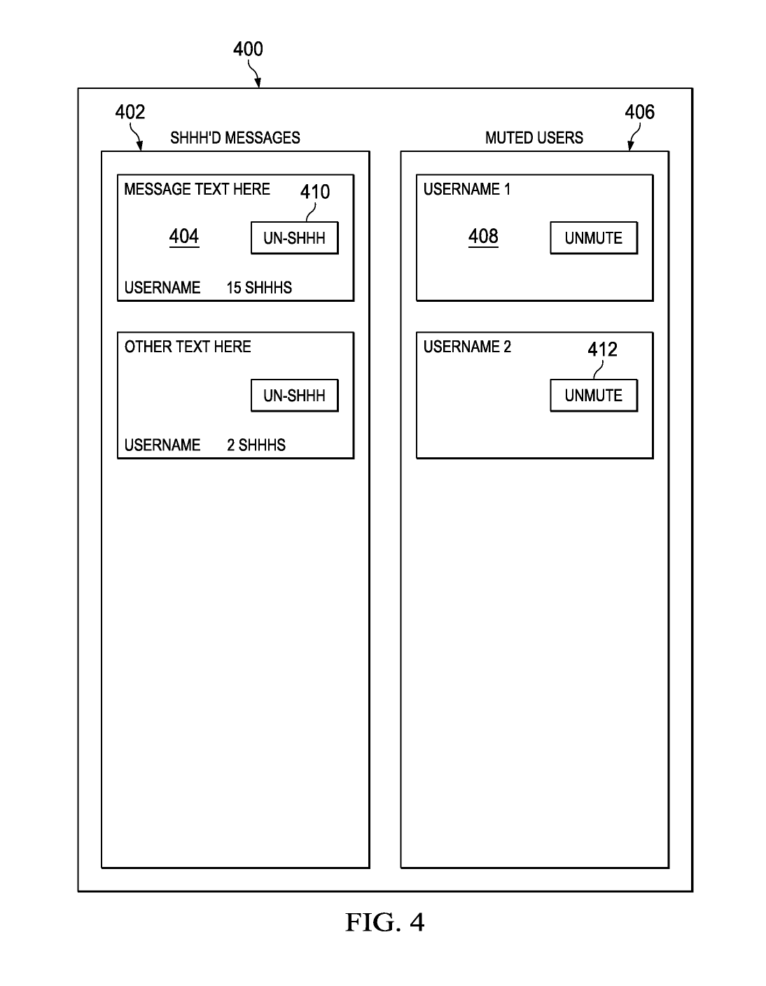

FIGS. 3-4 are schematic drawings of illustrative user interface screens showing a map with messages symbolized and other user information;

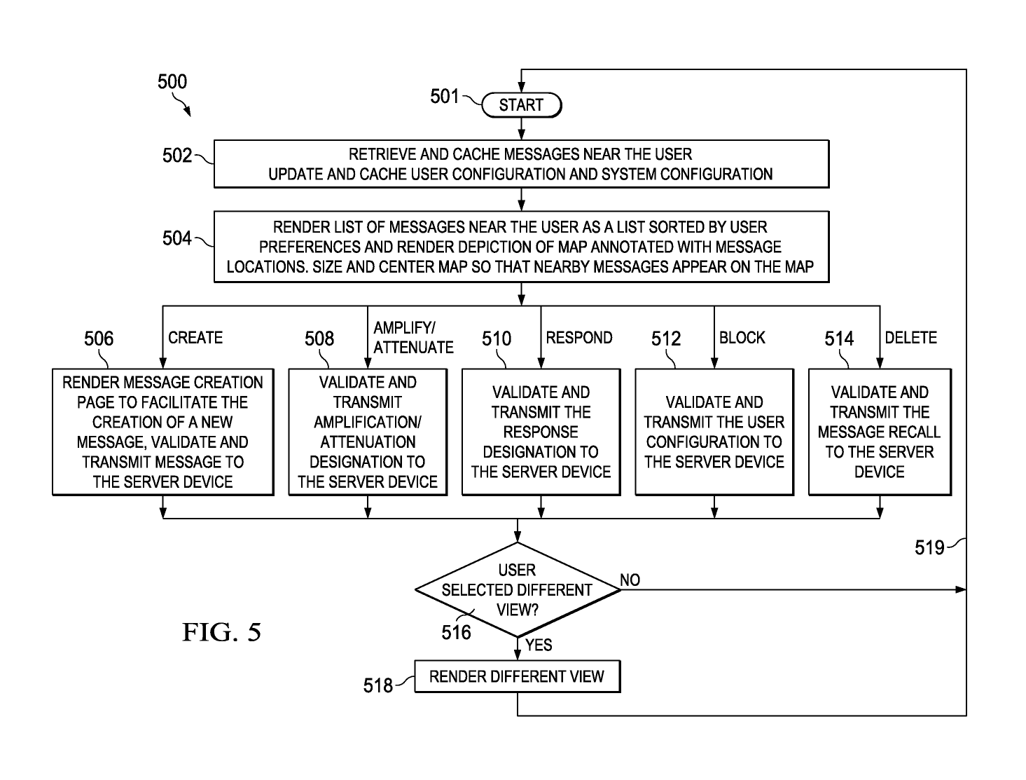

FIG. 5 is a flowchart illustrating one example of functionality implemented as portions of the communication application executed in a client in the networked environment of FIG. 1 according to various illustrative embodiments of the present disclosure;

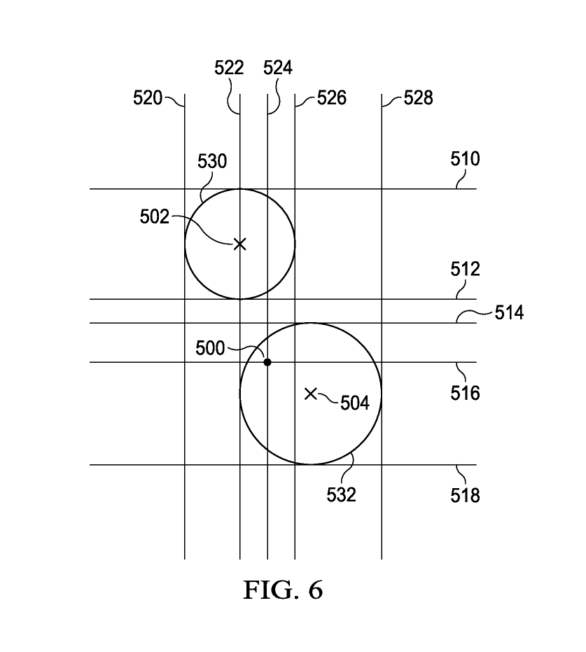

FIG. 6 is a schematic diagram that provides one illustrative example of an approach used to select, from all existing messages, only those that are relevant to a specific user in a geographic area according to an illustrative embodiment;

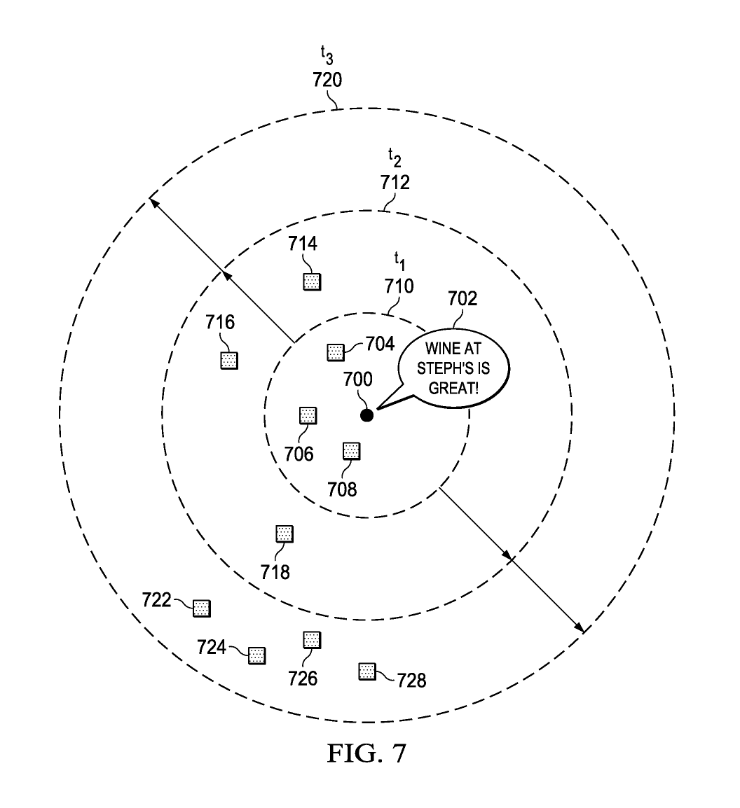

FIG. 7 is a schematic map over times t₁-t₃ showing the amplification of a message according to an illustrative embodiment;

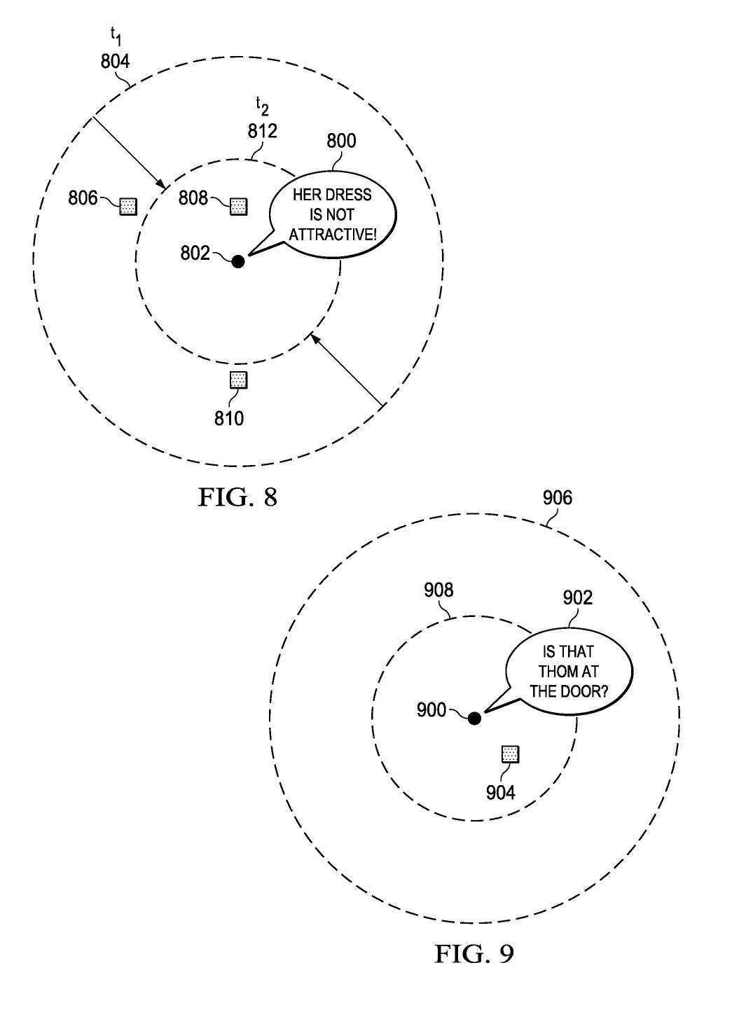

FIG. 8 is a schematic map over time t₁-t₂ showing the attenuation of a message according to an illustrative embodiment;

FIG. 9 is a schematic map showing the presentation of a message in whisper mode according to an illustrative embodiment;

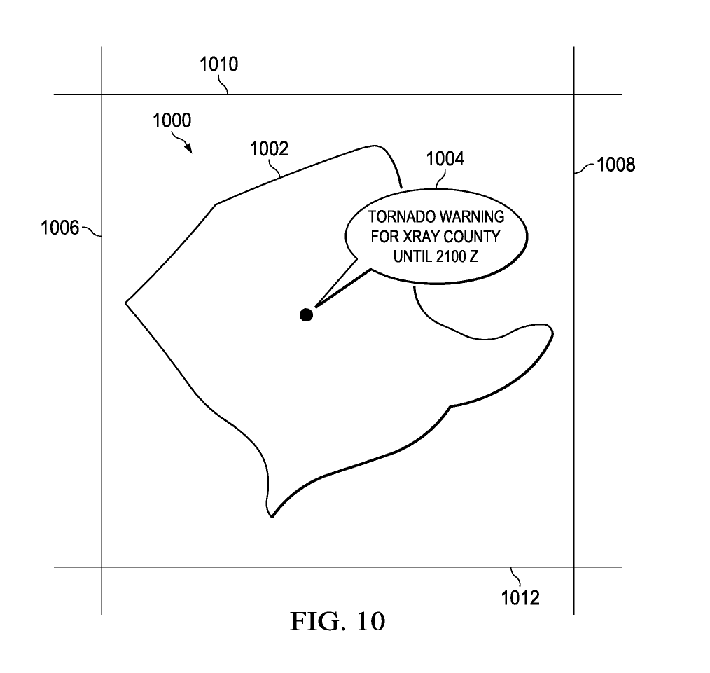

FIG. 10 is a schematic map presenting a message for a designated geographic area according to an illustrative embodiment;

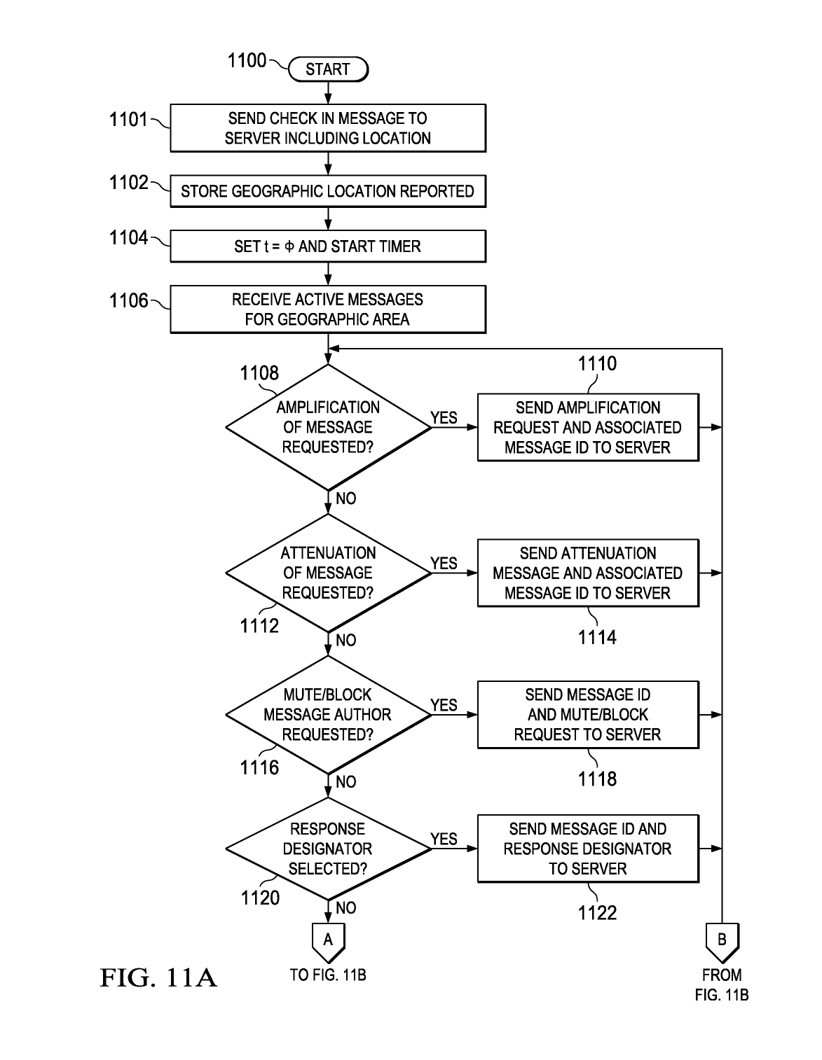

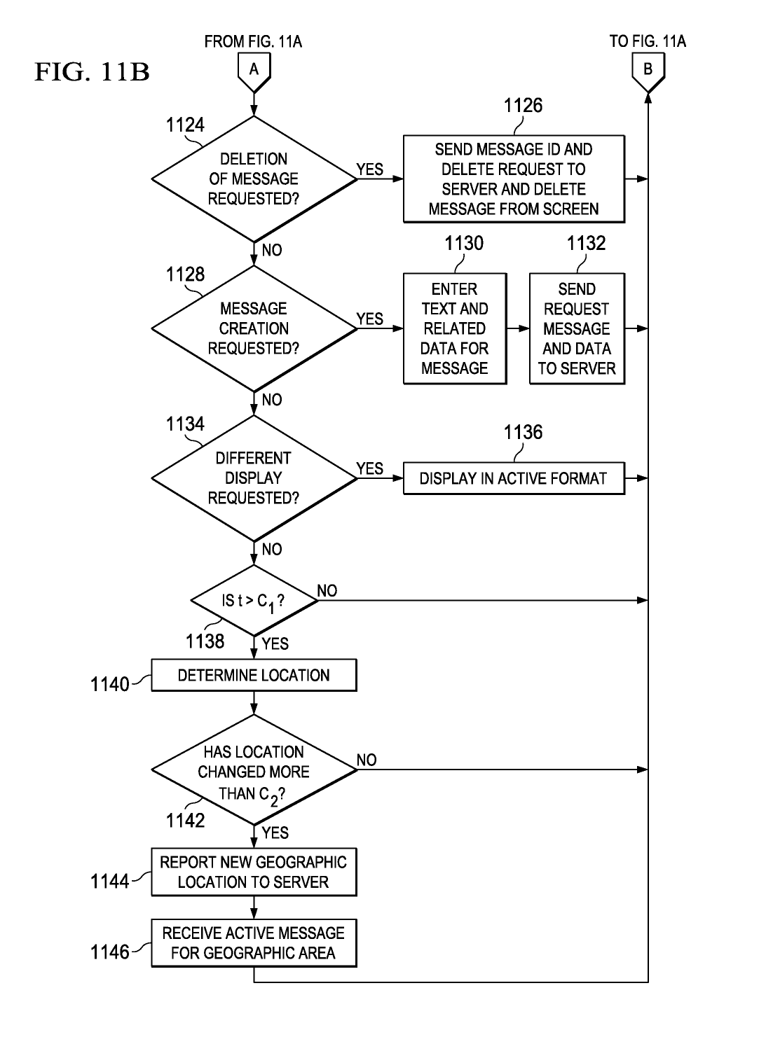

FIGS. 11A and 11B are a flow chart of an illustrative embodiment of a process executed on a personal digital device; and

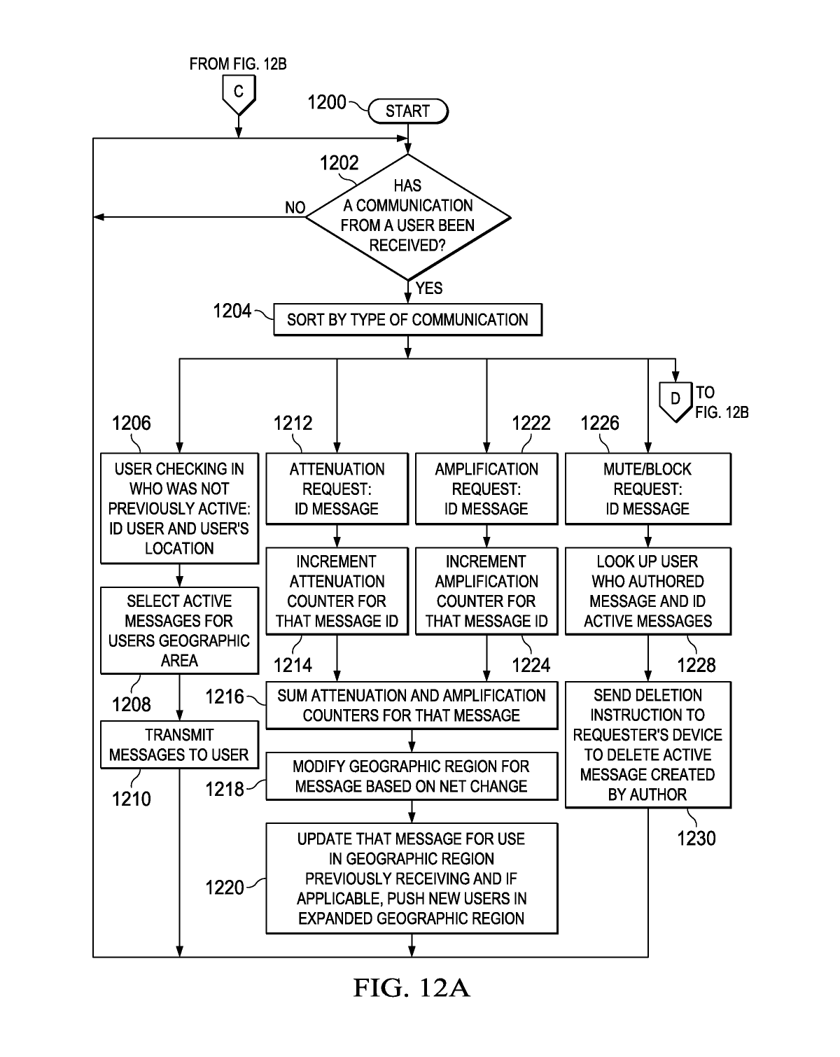

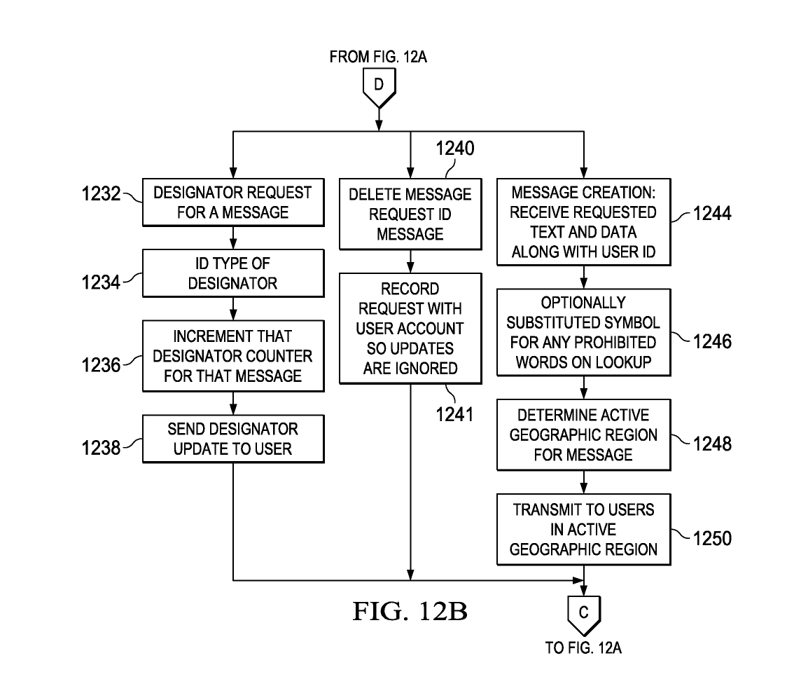

FIGS. 12A and 12B are a flow chart of an illustrative embodiment of a process executed on a server device.

### DETAILED DESCRIPTION

In the following detailed description of the preferred embodiments, reference is made to the accompanying drawings that form a part hereof, and in which is shown, by way of illustration, specific embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the claims.

It would be useful for people to be able to communicate with other people who are nearby without having to explicitly establish or declare a relationship between parties in advance, or to be able to participate in such communication without having to divulge the type of personal information often accompanied with the establishment or declaration of a relationship. As used herein, “or” does not require mutual exclusivity unless context clearly indicates otherwise. Often the establishment or declaration of one or more relationships among participants occurs as the primary aspect of applications sometimes referred to as social networking applications. However, a different context of communication is often desired between people who may or may not be related by anything more than their physical proximity. In such a case, individuals may wish to make an announcement or respond to an announcement specifically and only to others who are nearby.

For example, someone who has lost a pet may wish to make an announcement (in the form of a request for help) to everyone who happens to be physically present within a certain area of where the pet was lost. Or as another example, someone who is present at a sporting event may wish to make an announcement about the game to everyone physically at or nearby the event. Or as another example, an apartment dweller who has discovered that their cable TV is not functioning may wish to solicit a response from others who are physically nearby as to whether their cable systems are also non-functional. Or as still another example, a governmental agency may wish to make a public service announcement whose content is relevant only to citizens who are physically present in a particular geographic region; for example, a tornado warning or Amber Alert. These are merely examples meant to illustrate that people often wish to communicate with others to whom they are not necessarily related in any special way other than the commonality of their physical proximity. Numerous other examples might be given. With these and other communications, the user may wish to remain anonymous.

The present application describes various embodiments of systems and methods for message management, or communications, among physically proximate users. For example, in some embodiments, a user may browse and create messages from a mobile computing device, or personal digital device. The system retrieves a listing of all extant, active messages within the user's region. The system allows the user to see the content of messages whose broadcast range encompasses the current location of the user. The system also allows the user to generate a message that can be accessed by other users who are within that message's “broadcast range”. The broadcast range of a message may be determined at the time of creation by the system by considering various conditions such as the user's preferences, prior actions of the user, the location from which the message was broadcast, system configuration settings, or other conditions which may be stored in or derived by the system. Additionally, the broadcast range of a message may change according to any of the aforementioned conditions and other conditions as well; such as, the passage of time which would represent the age of a message, the number of amplification/attenuation actions (as described below) applied to a message, the number of responses a message has received, or other conditions which may be stored in or derived by the system.

Users may interact with a message by declaring their intention to amplify or to attenuate a message. Other interactions are possible as well. A user may perform some action, such as tapping a button, executing a menu selection, or performing a specific touch gesture such as “swipe” on their device, to declare the intention to attenuate or amplify. The system will register the user's intention and may subsequently alter the broadcast range, or communication zone, of that message. Users may register their intention to amplify or attenuate a message even if they did not create the message based on said input. In some embodiments, the system may prevent a user from registering an intention to amplify or attenuate a message that they created themselves. In other embodiments, users may be allowed to register such intentions only under certain conditions such as an account in which such privileges have been granted or have been purchased. The system keeps a tally of all amplification/attenuation declarations, and may display this tally to users as part of the display of the message.

Users may create a message by entering the text of the message and by entering other message configuration details or by overriding default configuration details. Other configuration details may include the nametag the user wishes to adopt for the message. The nametag of a message is a name the user has selected to identify themselves (among other users) as the author of the message. Other configuration details may include the color, font, font size, or other visual rendering selections of the message. Additionally, a user may select for inclusion one or more response designators to accompany a message. Two or more designators may be used to allowing voting for quick, local surveys. When a message created with a group of response designators is displayed to users, the viewing user may select one designator from among the group as the user's response to the message. The system keeps a tally of all response designators of a message, and may display this tally to users as part of the display of the message.

Users may configure their participation in the system by blocking the author of a message. Blocking the author of a message declares to the system that the user does not want to see any messages authored by an individual. The system may then obscure or disable messages that were authored by the blocked user from being displayed on the device of the blocking user.

Users may declare their intention that they wish to delete a message that they previously created. The system may then designate that the message is no longer to be broadcast to users.

Referring now to the drawings, and initially to FIG. 1, an illustrative networked environment 100 according to various embodiments is presented. In various embodiments, the networked environment 100, or distributed data processing environment or system, may include a plurality of shared resources. Shared resources may include, for example, without limitation, a variable, a data object, a persistent session object, a database, a table, a record, a list, a field, a memory region, a register, an I/O device, a file, a folder, a directory, a network connection, and the like. The networked environment 100 includes a server device 104 or devices, a client 110, and a network 108. The network 108 is typically a cellular network or mobile network or any wireless system, including without limitation, Global System for Mobile Communications (GSM), General Packet Radio Service (GPRS), cdmaOne, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN). In other embodiments, the network 108 may include, for example, the Internet, intranets, extranets, wide area networks (WANs), local area networks (LANs), wired networks, wireless networks, or other suitable networks, etc., or any combination of two or more such networks.

The server device 104 may include, for example, a server computer or any other system providing computing capability. Each server device 104 may include a different configuration of hardware and software modules. For example, the service device may include a server computer, which may have different types and quantities of processors, different application programs and different peripherals. Additionally, the communication path between computers of the networked environment may include a number of networking components, for example, but not limited to, firewalls, routers, proxies and gateways. In some embodiments, the networked environment may be specifically configured to run distributed applications. Each portion of a distributed application, in addition to being configured for proper operation in a stand-alone mode, may also be configured to appropriately communicate with other portions of the distributed application, as well as other computers in associated networked environment.

In some embodiments, a plurality of server devices 104 may be employed that are arranged, for example, in one or more server banks or computer banks or other arrangements. For example, a plurality of server devices 104 together may comprise a cloud computing resource, a grid computing resource, or any other distributed computing arrangement. Such server devices 104 may be located in a single installation or may be distributed among many different geographical locations. For purposes of convenience, the server device 104 is referred to herein in the singular. Even though the server device 104 is referred to in the singular, it is understood that a plurality of server devices 104 may be employed in the various arrangements as described above.

Various applications or other functionality may be executed in the server device 104 according to various embodiments. Also, various data is stored in a data store 136 that is accessible to the server device 104. The data store 136 may be representative of a plurality of data stores as can be appreciated. The data stored in the data store 136, for example, is associated with the operation of the various applications or functional entities described below. The components executed on the server device 104, for example, include application(s) 134, a network interface application(s) 140, and other services, processes, systems, engines, or functionality not discussed in detail herein.

The application 134 or other programs of the environment 100 be stored on one or more computer-readable tangible storage devices, which may include internal storage on server computer and downloaded to a data processing system or other device for use. The applications may communicate via remote processes, such as in accordance with a signal having one or more data packets (for example, but not limited to, data from one program interacting with another program in a distributed data processing system, and/or across a network with other systems via the signal). Data gathered, generated, and maintained for use by application may be kept in internal storage of the server computer or device or in one or more databases of stores 136. The data store may receive data and also programming.

In some embodiments, the data store 136 includes, for example, messages 160 and information related to users 170 and settings 180. The messages 160 may include for example message status 162, message location 164, message interactions 166, and message configuration 168. The message status 162 may include information about the creator of the message, the broadcast range of a message, the text of the message, the intended broadcast range (communication zone) or lifespan of the message, visual appearance of the message, and other details of the message which would allow its presentation and manipulation by a message management system 150. The message location 164 may include information about the location of the user when the message was created or the intended center of broadcast for the message. The message interactions 166 may include details and tallies of the interactions that users have made with a message, for example the number of registered amplifications and attenuations a message has received, and the details and tallies of the registered responses a message has received. The message configuration 168 may include settings and parameter values which allows the message management system 150 to manage a message's broadcast range (communication zone), lifespan, and interaction, for example the group of response designators.

Users 170 may include for example user information 172, user location 174, and user configuration 176. The user information 172 may include device identifiers, their authorization status, and usage statistics. The user location 174 may include the current user's location, recent locations, and location accuracy estimates. The user configuration 176 may include status of the user's device, a list of known messages cached on the device, the time and type of the last interaction with the user, the list of users that the user has blocked, the default nametag of the user, default message color of the user, and other user preferences.

Settings 180 may include for example system information 182 which may include for example, parameters to govern the types of messages, the default and allowable broadcast range (communication zone) of messages, geographic region designators to allow the system to automatically allocate/deallocate additional server devices 104 based on conditions such as number of users within a geographic region or the number of requests serviced by a server device 104, the current status of the system, and other values to allow the message management system 150 to manage user messages and to optimize the processing resources in order to do so efficiently.

The client device 110 includes for example the message application 112. The message application 112 allows the user to communicate with other users as described herein, using the server device(s) 104. The client device 110 communicates via network 108 with the server device(s) 104.

The client device 110, or personal digital device, includes location services 114 which provide the capability of the device to determine its location within some accuracy. The client device 110 may use GPS hardware or a wifi-location database or cellphone tower triangulation or other methods. Different methods may have varying degrees of accuracy. In one illustrative embodiment, the client device is an IPHONE device, ANDROID device, tablet, smart phone, or other personal digital device.

The message application 112 may render various screens such as FIGS. 2A, 2B, 3, and 4 in order to facilitate the management of messages for example, by executing a computer program. In one embodiment the computer program follows the logic shown in FIG. 5. Other screen presentations, of course, are contemplated.

The networked environment 100 is an illustrative diagram of an environment in which embodiments may be implemented. It should be understood that FIG. 1 is only provided as an illustration of one implementation and is no intended to imply any limitation with regard to the environments in which different embodiments may be implemented. Many modifications to the depicted environment may be made.

FIG. 2A shows an illustrative message display list 200 that displays one or more messages 202. Each displayed message 202 may include a username or nametag 204 and the content of a textual, audio, or visual message 206. The message may also include a group of response designators 208 such as a happy face 222, “lol” 226, “ok” 228, numerals (e.g., 1, 2, 3, 4, etc.) or other designator 230, and the total number of users who responded using that response designator referred to as a tally 218, a block action (or mute) button 210, a message age designator 212, a count of the number of amplification requests 214 (or “cheers”), a count of the number of attenuation requests 216 (“shhhs”), and a recall request button or symbol 220. In some embodiments, the response designators could include emoji images or other non-language symbols. A displayed message 202 may include all of the details and possible actions associated with a message or may display only a subset of possible details and actions. This inclusion or exclusion may depend upon the conditions determined by the client device 110 or the server device 104. An attenuation request by a user may be interpreted by the system as a request to filter the attenuated message from the list of currently displayed messages. Where a button or symbol is otherwise displayed to a user to enable an interaction with the message, certain devices that permit various types of touch or physical interactions may substitute the use of such a gesture or interaction in the place of a tap onto a button or symbol; for example a swipe up or right of a message may be understood to designate an amplification intention by the user or a swipe down or left of a message may be understood to designate an attenuation intention by the user, or shaking the device may be understood to designate a reshuffling of displayed messages.

Referring now to FIG. 2B, another illustrative embodiment of a user interface 240 for use as part of the system and methods herein is presented. The user interface 240 is for example on a touch screen of a smartphone. The user interface 240 includes in this example a background 242 that may be a picture or image that may be remain the same or may change with the time of the day, e.g., dawn, day, dusk, and night backgrounds. A company logo 244 may be included at some location and remain on each screen presentation. Typical smart phone symbols 246 may be included as shown at the top. The series of dots below the symbols 246 may used to provide access to additional pages, such as for configuration screens. An advertisement banner 248 may be included on a portion of the interface 240.

A first message 250, a second message 252, and a third message 254 are shown presented on the user interface 240. The messages 250, 252, 254 may be transparent or translucent to allow all or a portion of the background to be seen through therethrough. Each message has age or elapsed time display 256 and a nametag 258. An amplification, or cheer, button 260 is shown on the third message 254. The amplification button 260 includes a counter display 262 that currently shows 0, i.e., no one else has cheered. In some embodiments, the absence of a number may also indicate no responses. In this illustrative embodiment, to attenuate the message, a right to left swipe motion is used. In addition, the third message 254 has three response designators 264, which may different shapes and colors. Finally each message 250, 252, and 254 includes text 266 that has been entered by an author. A picture or audio may also be used along with text or in lieu of text. In this illustrative embodiment, the large plus sign (“+”) 268 in the upper right corner is the button used to initiate a new message. In some illustrative embodiments, a menu may be included to allow different views including one with a map.

Referring now primarily to FIG. 3, another illustrative user interface screen 300 displaying a map along with annotations meant to symbolize the existence of a message is presented. A message symbol 302 may show the location at which a message was created and a message radius 304 may show the current broadcast range (communication zone) of the message. A user symbol 306 may designate the current location of the user's device. A message token 308 may display a summary of the message, for example a single word from a textual message may be selected to annotate the message symbol 302. In one illustrative embodiment, the selected word may be the word which has the rarest usage evidenced by some listing of word usage frequencies. In other another embodiment, the selected word may be the word that has the rarest usage from among the messages whose broadcast ranges encompass the user's current location. Other selective criteria may be used. Illustrative message symbols 310, 312, and 314 are shown with tokens 316, 318 and 320 respectively. The map may include geographic landmarks such as street 322. A user may select a message token, e.g., token 308, to see the entire message.

Referring now primarily to FIG. 4, another illustrative user interface screen 400 displaying the results of some types of interaction and allowing the user to revoke such interactions is presented. For example, the messages against which the user has issued an attenuation request may be displayed in an attenuated message list 402 and the list of blocked users may be displayed in a blocked user list 406. Because the message application 112 (FIG. 1) may be configured to filter the display of such messages from the message display list 200, users may need a way of revoking the attenuation request from an attenuated message 404. Certain details of an attenuated message 404 may be displayed along with an attenuation revocation button 410 or symbol that allows the user to revoke the attenuation request. Because the message application 112 (FIG. 1) may be configured to filter all messages created by a blocked user, users may want a way of revoking the block request 408 against a user. Certain details of a blocked user may be displayed along with a block revocation button 412 or symbol that allows the user to remove the block. In another illustrative embodiment, users may revoke all block requests with a single action.

Referring now primarily to FIG. 5, one example of the operation of a portion of the message management system 150 and its interaction with the message application 112 is presented. It is understood that the flowchart of FIG. 5 provides merely an example of the many different types of functional arrangements that may be employed to implement the operation of the portion of the message management system 150 as described herein. As an alternative, the flowchart of FIG. 5 may be viewed as depicting an example of steps of a method implemented in the client device 110 (FIG. 1) according to one or more embodiments. The order of steps presented here (and in other embodiments) is not intended to be limiting. In addition, the flowchart of FIG. 5 provides one example of how a user interacts with the message application 112 when the users browse or create messages (FIG. 2, 3), where it is understood that the flow may differ depending on specific circumstances. In addition, it is understood that the user interfaces 200, 240, 300, 400 described above are merely illustrative examples of the various types of interfaces that may be employed to accomplish the same purposes. Consequently, the extent that user interfaces 200, 240, 300, 400 are mentioned below in conjunction with processes, it is understood that such user interfaces 200, 240, 300, 400 are merely discussed as examples. Also, as described below, the user interfaces 200, 240, 240, 300, 400 are linked together by virtue of various graphical components such as buttons and the like that act as links. It is understood, that other flows and linkages between various user interfaces 200, 300, 400 (FIG. 2, 3, 4) may be employed other than those described herein to accomplish the same functionality.

The process or method 500 begins at 501 and then at box 502 the message application 112 retrieves and caches a list of messages and may also retrieve and cache a set of user configuration details or a set of system configuration details from the server device 104. The message application 112 on a client device 110 may contact a particular instance of a service device 104 by calculating the address of the service device 104 based on for example its current location or based on for example communication with one or more default server devices 104. When ready, the message application 112 then proceeds to the logic of box 504 whereby the list of messages is presented to the user as for example 200 (FIG. 2) or 300 (FIG. 3). The user may then indicate how they would like to interact with the messages for example tapping a button or symbol or by performing a touch gesture or by shaking the device or by another interaction with the device which can be interpreted as indicating the selection of one of various action requests, for example create 506, amplify/attenuate 508, respond 510, block 512, delete 514 or another operation.

When the user initiates the creation of a message 506, the message application 112 may allow the input of text for a message (or audio or video) and the input of message parameters such as broadcast range (communication zone), message lifespan, nametag (user ascribed name for the message as seen by others) and message color or other visual effects. Upon validation the message content and other details are transmitted to the server device 104 which may save the details of the message in messages 160 (FIG. 1) and may configure the details of the message in messages 160 (FIG. 1) for example by calculating details about the message (FIG. 6) for subsequent efficient broadcast to other users whose locations are encompassed by that message's broadcast range (communication zone).

When the user initiates an amplification/attenuation request 508 for example via 214 (FIG. 2A) or via 216 (FIG. 2A), the message application 112 may validate and transmit the request to the server device 104 which may save the request and may alter the details of the message in messages 160 (FIG. 1), for example by incrementing the tally of the number of amplification or attenuation requests of the message.

When the user initiates a response 510, the message application 112 may validate and transmit the response to the server device 104 which may save the response and may alter the details of the message in messages 160 (FIG. 1), for example by updating the tally of the response designators of the message.

When the user initiates a block 512, the message application 112 may validate and transmit the block to the server device 104 (FIG. 1) which may save the block and may update the user of the users 170 (FIG. 1) and the settings 180 (FIG. 1) to reflect that the requesting user has blocked the author of the message. As used herein, “validate” is an optional operation to check some aspect of the message to address security or protocol matters. For example, validation of a created message may include checking that the character length of the message is within range and that there are no character sets or items that a malicious hacker might want to add. As another example, for an attenuation request, the validation may verify that the user is not attempting to attenuate their own message. As still another example, a user may not be allowed to block herself or himself. These are only some examples and those skilled in the art will appreciate that others may be used.

When the user initiates a delete 514, the message application 112 may validate and transmit the request to the server device (FIG. 1) which may alter the details of the message in messages 160 (FIG. 1), for example by updating the status of the message to reflect that the message should no longer be displayed to any users.

The user may select a different view at 516 in some embodiment. The message application 112 may perform another refresh of box 502 with respect to messages and user configuration and system configuration at various points.

In some embodiments, if a user has the application running on his or her mobile device, but the screen is not active, a push notification can be used to present the message or information concerning the message or messages to the user. The push notifications may omit attenuated messages or messages on which a profanity filter has removed or replaced text. Push notifications may also be omitted based on other characteristics.

Referring now primarily to FIG. 6, an illustrative approach that may be used to determine which messages have a broadcast range that encompasses the current location of the user is presented. An efficient approach is desired because in many embodiments the user's location will change and in many embodiments the broadcast range of messages will be continuously changing. The server device 104 (FIG. 1) and client device 110 (FIG. 1) may coordinate user locations and message locations and message broadcast ranges. This coordination may involve the selection of a few messages for a particular user from among an unknown number (which may be millions or even billions) of messages.

A user 500 is located at a position represented by latitude 516 and longitude 524. The message management system 150 (FIG. 1) selects from among available messages only those messages whose broadcast range encompasses user 500. To perform the selection, four values are maintained for each message: the upper latitude (UPLAT), the lower latitude (LOWLAT), the eastern or right-side longitude (RLONG), and the western or left-sided longitude (LLONG). These values form the box which most tightly encompasses the circle from the message's location as its center and the broadcast radius as the circle's radius. When a user is known to be present at a given latitude (USERLAT) and longitude (USERLONG) only those messages whose calculated values meet the following criteria relative to the user's location values can possibly have a broadcast radius which encompass the user:

(1) The LLONG value of the message must be to the west of the USERLONG value of the user;

(2) The RLONG value of the message must be to the east of the USERLONG value of the user;

(3) The UPLAT value of the message must be to the north of the USERLAT value of the user; and

(4) The LOWLAT value of the message must be to the south of the USERLAT value of the user.

This approach may be embodied by the numerical assignment of the values of LLONG, RLONG, UPLAT, LOWLAT, USERLONG, USERLAT corresponding to the conventional uses of latitude and longitude values. In such an embodiment, the approach compensates for such assignment to the extent that certain boundary crossings (for example, at either meridian or either pole) occur within the box represented by the four values of the message.

FIG. 6 may be used to further illustrate the approach. The message 502 has broadcast radius 530 which does not encompass user 500, and message 504 has broadcast radius 532 which does encompass user 500. The approach selects message 504 without selecting message 502 or any other message like message 502 (that is, any other message whose broadcast radius does not encompass user 500). The four values for message 502 which represent radius 530 correspond to lines 510 (UPLAT), 512 (LOWLAT), 520 (LLONG), and 526 (RLONG). The four values for message 504 which represent radius 532 correspond to lines 514, 518, 522, 528 which respectively are assigned to UPLAT, LOWLAT, LLONG, RLONG. When the location of user 500 is identified corresponding to lines 524 and 516 they are assigned respectively to values USERLONG and USERLAT.

The application of this approach for the selection of messages considers the likely location of the client devices 100 (FIG. 1) and ignores selections for users located at or very near either meridian or either pole. The Boolean selection criteria is then:

(LLONG<=USERLONG) && (RLONG>=USERLONG) && (UPLAT>=USERLAT) && (LOWLAT<=LOWLAT)

Messages satisfying the criteria are delivered to the user. Other criteria may be required as well in some embodiments.

According to one illustrative embodiment, a local communication system is presented that involves communication with a mobile communication device, or a personal digital device, in a limited geographic region. The digital device is registered or checked in with a server over a wireless telecommunications network or Wi-Fi in conjunction with the internet, or other communication means that is wireless. The registration or check-in includes providing geographic location data to the server. The server may determine the position in some embodiments or may request the information from the device and in other embodiments the device may transmit its position without external prompting.

The server then provides active messages for that geographic area or region to the user. The user may read, attenuate, amplify, or delete the message or may mute the creator of the message. Other activities could be involved with the messages as well. In one aspect, amplifications, which may be referred to as “cheers”, increase the geographical weight of a message. Typically the geographical weight means the active geographic area. In some embodiments, increasing the geographical weight could mean holding the same boundaries, e.g., within a certain range of a stadium, but making the message more pronounced, bigger, different color, etc. Attenuating the message decreases the geographical weight of the message. The server will net the attenuations and amplifications to arrive at the net change to the geographical weight. If the net is towards the attenuation, the geographical weight will decrease and could even go to zero. If a user arrives and receives the message and neither amplifies nor attenuates, the message will nonetheless decay at a specified rate of decay; that is, the geographical weight of the message will decrease until it goes to zero unless it is amplified. In one embodiment, an absolute time deadline is provided for messages; for example, a maximum duration of a message may be seven hours even if it is amplified. In other embodiments, there is no time limit as long as adequate amplifications are received to maintain the message in the geographic area.

With reference to an earlier example, if the power goes out, User A who is at home may create a message that says, “Power is out in my house on the 3200 block of Busy Street.” User B next door may cheer and the initial geographic weight will increase, which in this embodiment means the geographic area is enlarged. A User C may cheer and the geographic weight will further increase. In another embodiment, the initial message posted by User A may have associated buttons or designators that allow the users to explicitly acknowledge the same condition or provide other designations for the message. And in still another embodiment, the subsequent users may be able to vote on options provided in the message. For example, a performer at a concert may present a message to the audience that allows them to vote on what the next song will be as between two or more options. Or, a college lecturer might be able to put a question to the class with a requested vote on a multiple choice question.

Referring now primarily to FIG. 7, a schematic diagram of a map is presented. A user located at a first position 700 has created a message 702. For example, the message may say, “Wine at Steph's is great!” The message is delivered from the first user's digital device to the server where it may be processed or checked for certain criteria and then it is delivered to other users 704, 706 and 708 within the initial geographic area 710. User 704 may select the amplification button associated with message 702. The server receives the amplification request and if this changes the net attenuation/amplification tally, the geographic weight will be increased, e.g., the region or area may be expanded to a second area 712. By expanding to area 712, additional users 714, 716 and 718 are now included. Thus, the server pushes the message 702 to these additional users 714, 716 and 718. Thus at a first time, t₁, the message only had the reach of area 710 but at a second time, t₂, it has an area of 712. Similarly, if additional users such as user 716 or user 708, amplify the message such that the net attenuation/amplification is positive, the effective area for the message may be expanded again to area 720. By going to area 720, additional users 722, 724, 726, and 728 will now receive message 702 from the server. The process of expanding or decreasing the geographic areas may continue in response to the net attenuation/amplification of the message 702.

Referring now primarily to FIG. 8, an example is provided where a net attenuation occurs. In this example the user creates a message 800 that is associated with location 802. The initial geographic region is defined by area 804. Thus, users 806, 808, and 810 receive the message. The message 800 in this instance may be something disliked by a number of the hearers, such as, “Her dress is not attractive!” In response, one or more users may attenuate the message. If user 806, for example, attenuates the message and the net attenuation/amplification tally is in favor of attenuating, the effective area will decrease to area 812 and only user 808 will still show the message. If the message is further attenuated by other users who arrive or the like, the geographic area may decrease to zero and be removed from all users. Thus in this illustration the area went from area 804 at t₁ to area 812 t₂.

In one illustrative embodiment, the system may include a whisper mode. In this mode, the user may signal on their digital device that they would like to create a message that has a much smaller geographic area associated with it. This is illustratively demonstrated in FIG. 9. For example, a first user at location 900 may create a message 902 and indicate a desire for it to be in whisper mode. In this instance, the message may be, “Is that Thom at the door?” The user may only want a friend and fellow user 904 at the next table to receive the message and so requests whisper mode. Had the whisper mode not been selected, the default geographic region may have been 906, but in whisper mode, the area is greatly reduced as shown by area 908. In addition, the decay rate may very short immediate once responded to.

In some embodiments, certain authorities, organizations, or purchasers of rights, may send a message through the server to all the people in a geographic region with a message that remains available to users who check into that geographic area. Referring, for example, to FIG. 10, a map 1000 is shown. The map includes the border of a county 1002. If, for example, the National Weather Service issues a tornado warning for the county 1002, authority can be given to the National Weather Service to send a message to the geographical area that includes county 1002 and will not expand or decrease but will simply remain for a designated period of time. Thus, the message 1004 may read, “Tornado warning for X-Ray County until 2100Z.” and the area may be defined by left longitude 1006, right longitude 1008, upper latitude 1010 and lower latitude 1012. Other examples, may be where a park ranger is given the ability to place a warning in a State Park that remains for the whole park of some situation for a period of time; for example, the message might read, “Aggressive bear in area, use caution.”

Referring now primarily to FIGS. 11A and 11B, one illustrative process flow for an application on a personal digital device is presented. Again, those skilled in the art will understand that there are numerous variations, permutations, and modifications that may be made for carrying out various options of functionality. The process begins at step 1100 and goes to process box 1101 where the personal digital device sends a check-in or registration message to the server including location or geographic position. The message may be sent over the wireless network as previously referenced. The check-in may be initiated by the device or by the server. At step 1102, the geographic location and other data is stored in connection with a profile associated with the user identification. At step 1104, a timer may be initiated. At step 1106, the device receives active message(s) for the geographic area that were transmitted from the server.

At interrogatory box 1108, consideration is made as to whether the user has requested amplification of a message. If yes, an amplification request and the associated message identification are sent to the server at step 1110. If not, the process continues to interrogatory box 1112, where the process considers whether an attenuation request of a message has been requested. If so, at 1114, the digital device sends an attenuation message and the associated message identification to the server. If not, the process continues to interrogatory box 1116, where the process considers if the user has requested that a message author be muted or blocked. If so, the communication with the message id and the request is sent to the server at 1118. If not, the process continues to 1120.

At 1120, the process considers if a designator has been selected. A designator may be a particular response on a message, such as smiley face indicating approval, a frown, a remark such as “lol”, numerals, etc. If such a request has been made, the message identification and the designator identification are sent to the server at 1122. If not, the process continues to interrogatory box 1124 where the process considers whether a request has been made to delete a message. If so, a communication with the message identification and the deletion request are sent to the server and the message is deleted from the screen of the digital device at 1126. If not, the process continues interrogatory box 1128 that considers whether the user would like to create a message.

If the user would like to create a message at 1128, the user enters the text for the message, which may have a limited number of characters, such as 150 characters, or some other number, and any other related data for the message at 1130. The message request and data are sent to the server at 1132. If the answer to interrogatory box 1128 is negative, the process continues to interrogatory box 1134, which considers if a different display is requested. If so, the display is reformatted at 1136, and if not, the process continues to interrogatory box 1138.

Interrogatory box 1138 asks if the timer (initiated back at step 1104) has a reached a predetermined value, C₁. If so, the location of the device is determined at 1140 and then consideration is given as to whether the current location of the digital device has changed more than a predetermined constant, C₂, at interrogatory box 1142. If the user has moved such that the digital device has moved more than that amount, the new location is reported to the server at box 1144 and the digital device then receives any new messages for its updated geographical area or location and messages that are not active in that area are deleted at 1146. Again, this is just one illustrative process and the steps may be in various orders and some may be omitted.

FIGS. 12A and 12B present an illustrative example of a flow process for the one or more servers that enable the digital devices to communicate with users in a local geographic area. The process begins at 1200 and proceeds to interrogatory box 1202, which asks if a communication has been received from a user. If so, the message is sorted by the type of communication at 1204.

If the message is a user checking in or registering who was not previously active, the process continues at step 1206 by identifying the user and the user's location from the communication. The server will then select active messages for that user's geographical area at step 1208. Those messages are then transmitted to the user at step 1210.

If the type of communication received is an attenuation request, the process continues at 1212 with the identification of the message, and the attenuation counter is incremented for that particular message identification at 1214. The attenuation counter and amplification counter may be summed to provide a net attenuation/amplification at 1216. If the net attenuation/amplification has changed from what it previously was, geographical weight of that message will be changed accordingly at 1218. The geographical weight is typically the geographic area. The server then updates that message by increasing the weight or decreasing the weight as appropriate for the users impacted a step 1220. If the user is still in the region, the new counts are provided for that massage. If the user is no longer in the active geographic region for the message, a message is sent to delete it from the digital device.

If the type of communication received at 1204 is a request for amplification, the process continues at 1222 with the message identification and with an amplification counter being incremented at 1224. The process continues to box 1216 as previously discussed.

In one illustrative embodiment, user biasing or reputation considerations may be considered. For example, if a user has a record of being frequently attenuated, the degree of attenuation may be greater once reached or reached with a lesser requirement. Likewise, a user with a record of not being attenuated over a lengthy period of use may be given a threshold for attenuation or a small degree of attenuation.

If the type of communication received or sorted at 1204 is a request that a creator or author be muted, or blocked, at box 1226, the server will look up the user who is associated with the authored message at 1228 and then sends a deletion instruction to the requester's device to delete all active messages created by that author at step 1230. The block request is also noted in the requesting user's profile which may be consulted before sending any future messages.

If the type of communication received at 1204 is a request to increment a designator on a message, the process continues at 1232 with identification of the message. The type of designator requested is identified at 1234 and the counter for that designator is incremented at 1236 for the message. The updated designation count is sent to the user's device for the geographic area for which that message is active at 1238.

If the type of communication received at 1204 is a request to delete a message, the process continues at 1240, where the message is marked as deleted or archived. In this illustrative embodiment, only the author of a message may request deletion in this way. Messages marked as deleted are no longer broadcast to devices and cannot be interacted with. A broadcast to all devices who are displaying the message may be sent to cause all the devices to remove that message from the display. The user's delete request is noted in their profile.

If the type of communication sorted at 1204 is a request to create a message, the process continues at 1244 where the server receives the requested text and data along with the user identification. The server may optionally have a routine to consider the content at step 1246. For example, in some embodiments, certain profanity may be scrubbed and symbols such as “@#*+” or humorous words may be substituted. In some embodiments, highly profane words may simply be deleted. The geographic region associated with that message is determined at 1248 and the message is sent to users in the active geographic region at 1250. Again, numerous modifications and other approaches may be taken without departing from those contemplated in this disclosure.

In one illustrative embodiment, the users with their personal digital devices may have a channel selection that allows messages to be sent exclusively to those who have that channel designation. Thus, for example, a company may want to be able to communicate in a crowd only with their people. They may obtain special authorization to have a channel so the messages are delivered only to their people in that region.

Numerous in-application purchases may be available to add additional functionality or longevity to aspects of the existing functionality. For example, one may pay to receive an extra geographical weight or area without requiring amplification. In some embodiments, the number of messages that may be created may be limited, but a user may acquire additional rights to create message by purchase. In another, an in-app purchase may slow or eliminate the decay rate of a message. While commercial content may be prohibited in many situations, explicit advertisements may be paid to be distributed within a defined region.

For example, in one illustrative embodiment, advertisers may purchase advertisements for presentation to users in a geographical area. Users may be given a toggle that allows them to choose whether to see such advertisements. Thus, a user may turn on that option or channel when going to a mall or shopping area to see what coupons or special deals might be available.

In many of the embodiments, the user is able to interact with the local messages by amplifying, attenuating, etc. and thus in many instances the local communication can be said to be dynamic. It should be understood that the attenuation, or shhh functionality, allows a geographically-proximate community to self-police the messaging.

In some embodiments, the message at the top of a user interface will be the message most recently interacted with by any user in the geographic region. In some embodiments, priming messages may be placed at various geographic locations that are positive to begin a local exchange of messages in a positive direction or a pre-selected direction.

According to an illustrative embodiment, a mobile application includes a machine readable code to perform the following steps: send a location declaration, or check-in message, to a messaging server, where the message includes the user's id and geographic location; receive active messages from the message server based upon the geographic location of the personal digital device; transmit an attenuation request to the message server to request that the geographic weight of a message be decreased; transmit an amplification request to the message server to request the geographic weight of the message be increased; and create a message and transmit the message to the message server.

In addition to the embodiments described above, many examples of specific combinations are within the scope of the disclosure, some of which are detailed below.

### Example 1

According to an illustrative embodiment, a method for a plurality of client devices to communicate in a geographic region using one or more messaging server devices includes for each client device: sending a location declaration to the one or more messaging server devices, where the message includes the client device's id and current geographic location, and receiving active messages from the one or more message servers based upon the client device being within a communication zone of a message, wherein the communication zone (broadcast range) is a space around an initial location of a particular message. The space may take various shapes, but often a box or circle is used. The method further includes transmitting from at least one client device an attenuation request associated with a first message of the active messages to the message server to request that the communication zone of the first message be decreased and creating from at least one client device a new message and transmitting the new message to the one or more message servers to be included in the active messages going out to the client devices in a communication zone.

### Example 2

This method may further comprising transmitting from at least one client device an amplification request associated with a second message of the active messages to the one or more message servers to request the communication zone (broadcast range) of the second message be increased.

### Example 3

The method of example 1, further comprising transmitting from at least one client device an amplification request associated with a second message of the active messages to the one or more message servers to request the communication zone of the second message be increased and wherein the communication zone is either increased or decreased depending on a net summation of amplification requests and attenuation requests. If the sum is in favor amplifications (positive sum of amplifications), the communication zone is increased. If the sum is in favor of attenuations (positive sum of attenuations), the communication zone is decreased.

### Example 4

The method of example 1, further comprising maintaining a record of attenuation requests issued for messages associated with each user, and wherein when a user has received more than a threshold number of attenuation requests thereafter reducing the communication zone by a greater amount than otherwise would occur upon reaching a positive attenuation request. In some embodiments, the threshold number be determined through calculation taking into account factors such as the location and time interval of attenuation requests. In essence, in one embodiment, if it is clear that a user is always being attenuated, the communication would bias to a smaller initial zone.

### Example 5

The method of example 1, further comprising creating from at least one client device a new message and transmitting the new message to the one or more message servers to be included in the active messages, wherein the step of transmitting the new message further includes transmitting a nametage and location coordinates.

### Example 6

The method of example 1, further comprising creating from at least one client device a new message and transmitting the new message to the one or more message servers to be included in the active messages, wherein the step of transmitting the new message further includes transmitting a nametage and location coordinates, and wherein the new message includes an item selected from the group of text, audio, or video.

### Example 7

The method of example 1, further comprising creating from at least one client device a new message and transmitting the new message to the one or more message servers to be included in the active messages, and wherein the new message includes response designators.

### Example 8

The method of example 1, further comprising creating from at least one client device a new message and transmitting the new message to the one or more message servers to be included in the active messages, and wherein the new message includes response designators; transmitting the new message to the plurality of client devices; and transmitting from at least one client device a designator response message.

### Example 9

The method of example 1, further comprising creating from at least one client device a new message and transmitting the new message to the one or more message servers to be included in the active messages, and wherein the new message includes response designators; transmitting the new message to the plurality of client devices; transmitting from at least one client device a designator response message; tallying response designator messages received for each response designator of the new messages; and transmitting the new message again with the tally included.

### Example 10

The method of example 1, wherein the specified distance is in the range of 50-150 meters.

### Example 11

The method of example 1, wherein the step of sending a location declaration further includes transmitting a channel selection and wherein the step further receiving messages associated with the channel selection.

### Example 12

The method of example 1, further comprising creating from at least one client device a new message and transmitting the new message to the one or more message servers to be included in the active messages, and modifying any screened words from the new message.

### Example 13

The method of example 1, further comprising decreasing the communication zone over time.

### Example 14

The method of example 1, further comprising transmitting from at least one client device a blocking message associated with an undesired message, looking up the user associated with the undesired message and blocking any future messages from the user associated with the undesired message with respect to the client device that transmitted the blocking message.

### Example 15

The method of example 1, further comprising:

transmitting from at least one client device an amplification request associated with a second message of the active messages to the one or more message servers to request the communication zone of the second message be increased and wherein the communication zone is either increased or decreased depending on a net summation of amplification requests and attenuation requests with positive amplifications leading to an increase and positive attenuations leading to a decrease;

maintaining a record of attenuation requests issued for messages associated with each user, and wherein when a user has received more than a threshold number of attenuation requests thereafter reducing the communication zone by a greater amount than otherwise would occur upon reaching a positive attenuation request;

creating from at least one client device a new message and transmitting the new message to the one or more message servers to be included in the active messages, and wherein the new message includes response designators; transmitting the new message to the plurality of client devices; transmitting from at least one client device a designator response message; tallying response designator messages received for each response designator of the new messages; and transmitting the new message again with the tally included;

wherein the step of creating from at least one client device a new message and transmitting the new message to the one or more message servers to be included in the active messages further comprises modifying any screened words from the new message; and

wherein the specified distance is in the range of 50-150 meters

### Example 16

A system for communicating between a plurality of client devices in a geographic region using one or more messaging server devices, the system comprising one or more processors, one or more computer-readable memories, one or more more computer-readable storage hardware devices, and program instructions stored on at least one of the one or more storage hardware devices for execution by at least one of the one or more of the processors via the one or more memories, the program instructions comprising:

program instructions to determine if a communication has been received from a client device of a user over a wireless communication system;

program instructions to determine if the user has been previously active during a current session;

program instructions for receiving a geographic location for a user;

program instructions to provide all active messages for a geographic region to the user; and

program instructions to receive an attenuation request associated with a first message having a communication zone from the user and to decrease the communication zone.

### Example 17

The system of example 15, wherein the program instructions further comprise program instructions to receive an amplification request associated with a second message, to sum amplification and attenuation requests and to increase or decrease the communication zone in response thereto.

### Example 18

The system of example 15, wherein the program instructions further comprise program instructions to receive a message from at least one client device, wherein the message includes an anonymous nametage and text.

### Example 19

The system of example 15, wherein the program instructions further comprise program instructions to receive a message from at least one client device, wherein the message includes at least one response designator.

### Example 20

The system of example 15, wherein the program instructions further comprise program instructions to receive from a client device a blocking message associated with an undesired message and program instructions to block all future messages from an author of the undesired message with respect to the client device transmitting the blocking message.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to”. Unless otherwise indicated, as used throughout this document, “or” does not require mutual exclusivity.

The steps of the methods described herein may be carried out in any suitable order or simultaneous where appropriate. Where appropriate, aspects of any of the examples described above may be combined with aspects of any of the other examples described to form further examples having comparable or different properties and addressing the same or different problems.

Although the present invention and its advantages have been disclosed in the context of certain illustrative, non-limiting embodiments, it should be understood that various changes, substitutions, permutations, and alterations can be made without departing from the scope of the invention as defined by the claims. It will be appreciated that any feature that is described in a connection to any one embodiment may also be applicable to any other embodiment. The order of methods steps described herein is not intended to be limiting and in many instances the order of steps may be modified.

What is claimed:

1. A method for a plurality of client devices to communicate in a geographic region using one or more messaging server devices, the method comprising:
for each client device,
sending a location declaration to the one or more messaging server devices, where the message includes the client device's id and current geographic location, and
receiving active messages from the one or more message servers based upon the client device being within a communication zone of a message, wherein the communication zone is a space around an initial location of a particular message;
transmitting from at least one client device an attenuation request associated with a first message of the active messages to the message server to request that the communication zone of the first message be decreased; and
creating from at least one client device a new message and transmitting the new message to the one or more message servers to be included in the active messages for a communication zone.

2. The method of claim 1, further comprising transmitting from at least one client device an amplification request associated with a second message of the active messages to the one or more message servers to request the communication zone of the second message be increased.

3. The method of claim 1, further comprising transmitting from at least one client device an amplification request associated with a second message of the active messages to the one or more message servers to request the communication zone of the second message be increased and wherein the communication zone is either increased or decreased depending on a net summation of amplification requests and attenuation requests.

4. The method of claim 1, further comprising maintaining a record of attenuation requests issued for messages associated with each user, and wherein when a user has received more than a threshold number of attenuation requests thereafter reducing the communication zone by a greater amount than otherwise would occur upon reaching a positive attenuation request.

5. The method of claim 1, further comprising creating from at least one client device a new message and transmitting the new message to the one or more message servers to be included in the active messages, wherein the step of transmitting the new message further includes transmitting a nametage and location coordinates.

6. The method of claim 1, further comprising creating from at least one client device a new message and transmitting the new message to the one or more message servers to be included in the active messages, wherein the step of transmitting the new message further includes transmitting a nametage and location coordinates, and wherein the new message includes an item selected from the group of text, audio, or video.

7. The method of claim 1, further comprising creating from at least one client device a new message and transmitting the new message to the one or more message servers to be included in the active messages, and wherein the new message includes response designators.

8. The method of claim 1, further comprising creating from at least one client device a new message and transmitting the new message to the one or more message servers to be included in the active messages, and wherein the new message includes response designators; transmitting the new message to the plurality of client devices; and transmitting from at least one client device a designator response message.

9. The method of claim 1, further comprising creating from at least one client device a new message and transmitting the new message to the one or more message servers to be included in the active messages, and wherein the new message includes response designators; transmitting the new message to the plurality of client devices; transmitting from at least one client device a designator response message; tallying response designator messages received for each response designator of the new messages; and transmitting the new message again with the tally included.

10. The method of claim 1, wherein the specified distance is in the range of 50-150 meters.

11. The method of claim 1, wherein the step of sending a location declaration further includes transmitting a channel selection and wherein the step further receiving messages associated with the channel selection.

12. The method of claim 1, further comprising creating from at least one client device a new message and transmitting the new message to the one or more message servers to be included in the active messages, and modifying any screened words from the new message.

13. The method of claim 1, further comprising decreasing the communication zone over time.

14. The method of claim 1, further comprising transmitting from at least one client device a blocking message associated with an undesired message, looking up the user associated with the undesired message and blocking any future messages from the user associated with the undesired message with respect to the client device that transmitted the blocking message.

15. The method of claim 1, further comprising:
transmitting from at least one client device an amplification request associated with a second message of the active messages to the one or more message servers to request the communication zone of the second message be increased and wherein the communication zone is either increased or decreased depending on a net summation of amplification requests and attenuation requests with positive amplifications leading to an increase and positive attenuations leading to a decrease;
maintaining a record of attenuation requests issued for messages associated with each user, and wherein when a user has received more than a threshold number of attenuation requests thereafter reducing the communication zone by a greater amount than otherwise would occur upon reaching a positive attenuation request;
creating from at least one client device a new message and transmitting the new message to the one or more message servers to be included in the active messages, and wherein the new message includes response designators; transmitting the new message to the plurality of client devices; transmitting from at least one client device a designator response message; tallying response designator messages received for each response designator of the new messages; and transmitting the new message again with the tally included;
wherein the step of creating from at least one client device a new message and transmitting the new message to the one or more message servers to be included in the active messages further comprises modifying any screened words from the new message; and
wherein the specified distance is in the range of 50-150 meters

16. A system for communicating between a plurality of client devices in a geographic region using one or more messaging server devices, the system comprising one or more processors, one or more computer-readable memories, one or more more computer-readable storage hardware devices, and program instructions stored on at least one of the one or more storage hardware devices for execution by at least one of the one or more of the processors via the one or more memories, the program instructions comprising:
program instructions to determine if a communication has been received from a client device of a user over a wireless communication system;
program instructions to determine if the user has been previously active during a current session;
program instructions for receiving a geographic location for a user;
program instructions to provide all active messages for a geographic region to the user; and
program instructions to receive an attenuation request associated with a first message having a communication zone from the user and to decrease the communication zone.

17. The system of claim 15, wherein the program instructions further comprise program instructions to receive an amplification request associated with a second message, to sum amplification and attenuation requests and to increase or decrease the communication zone in response thereto.

18. The system of claim 15, wherein the program instructions further comprise program instructions to receive a message from at least one client device, wherein the message includes an anonymous nametage and text.

19. The system of claim 15, wherein the program instructions further comprise program instructions to receive a message from at least one client device, wherein the message includes at least one response designator.

20. The system of claim 15, wherein the program instructions further comprise program instructions to receive from a client device a blocking message associated with an undesired message and program instructions to block all future messages from an author of the undesired message with respect to the client device transmitting the blocking message.
